(19) United States
(12) Patent Application Publication
(10) Pub. No.: US 2006/0240817 A1
(43) Pub. Date: Oct. 26, 2006

(54) Multi-wireless connection device

(76) Inventors: Masaru Akiyama, Tokyo (JP); Tamotsu Hattori, Tokyo (JP); Kenichiro Sakamoto, Tokyo (JP); Masayasu Fujino, Tokyo (JP); Takeshi Kujirai, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/115,546

(22) Filed: Apr. 26, 2005

(51) Int. Cl. H04Q 7/20

(52) U.S. Cl. 455/426.2

(57) ABSTRACT

Provided is a multi-wireless connection device that point-to-multipoint connects a communication link between a plurality of cellular phones to be connected to a cellular network, and a cordless phone that remote controls an outgoing call from the plurality of cellular phones to the cellular network or an incoming call from the cellular network to the plurality of cellular phones. The multi-wireless connection device maintains the synchronization within the Bluetooth network and performs point-to-multipoint connection by transmitting and receiving control data between the plurality of cellular phones via an ACL link.

### BACKGROUND OF THE INVENTION

The present invention relates to a multi-wireless connection device that point-to-multipoint connects the communication link between a plurality of communication devices to be connected to a communication network and a wireless communication device that remote controls such plurality of communication devices.

The technological progress in the wireless communication sector covers a broad range of areas, and various services are being provided. In the field of mobile cellular communication, provided are, for instance, personal mobile subscription services for seeking the convenience of domestic and business environments, and public mobile subscription services employing a public land mobile communications network. These services are provided via a cellular system.

Personal mobile services are provided via a personal mobile telephone network created based on personal cordless system standards such as the cordless telephone standards. A personal mobile telephone network is installed as an independent network, or by being connected to a fixed telephone network.

A public mobile service is provided via a cellular communications network created based on the automobile telephone service system standards, wide-area automobile communication system standards, or the like.

A cordless telephone service is provided via a cordless telephone communication system connected to a public telephone network.

In addition to these various services, the Bluetooth standard for mutually connecting various mobile terminals such as a portable phone or laptop computer with the peripherals thereof is being developed. The hands-free profile of this standard prescribes technical requirements for connecting a headset and a cellular phone via Bluetooth communication in order to prevent accidents as a result of using a cell phone while driving.

As documents referring to the foregoing communication technology, there are, for example, U.S. Pat. No. 5,913,163; U.S. Pat. No. 6,405,027B1; U.S. Patent Publication No. 2005/0020209A1; and US Patent Publication No. 2002/0132582A1.

### SUMMARY

Nevertheless, depending on circumstances in countries such as the United States and Canada, since the wireless zone to be covered with the base station is far and wide, radio waves become weak at the end of the wireless zone, and there are problems in that, when the user tries to use a cellular phone indoors, the radio waves of the cellular phone will not reach indoors. Further, in these countries, generally speaking, it is difficult for the radio waves to reach indoors since the interior space tends to be spacious.

Thus, in light of the foregoing problems, an object of the present invention is to provide a multi-wireless connection device that enables the reliable use of cellular phones indoors even when the radio wave environment is inferior.

In order to achieve the foregoing object, the multi-wireless connection device according to the present invention point-to-multipoint connects a communication link between a plurality of communication devices to be connected to a communication network, and a wireless communication device that remote controls the outgoing calls from the plurality of communication devices to the communication network, or the incoming calls from the communication network to the plurality of communication devices.

Here, for instance, a cellular network is preferable as the communication network. For example, a cellular phone is preferable as the communication device. For instance, a cordless phone is preferable as the wireless communication device. And, for example, a Bluetooth link is preferable as the communication link.

This multi-wireless connection device is able to maintain the synchronization within the Bluetooth network by transmitting and receiving control data between the plurality of communication devices via an ACL link.

Further, this multi-wireless connection device is also able to connect an SCO link with one of the communication devices by receiving a call status from the plurality of communication devices.

### DESCRIPTION OF DRAWINGS

FIG. 1 is a Bluetooth network configuration of the present embodiment;

FIG. 2 is an explanatory diagram of the Bluetooth profile;

FIG. 3 is an explanatory diagram of the packet format in Bluetooth communication;

FIG. 4 is an explanatory diagram of the packet header format in Bluetooth communication;

FIG. 5 is an explanatory diagram of the SCO packet;

FIG. 6 is an explanatory diagram of the ACL packet;

FIG. 7 is a sequence diagram describing the ACL automatic connection; and

FIG. 8 is a sequence diagram describing the initial registration procedures in the point-to-multipoint connection.

### DETAILED DESCRIPTION

(Bluetooth Network Configuration)

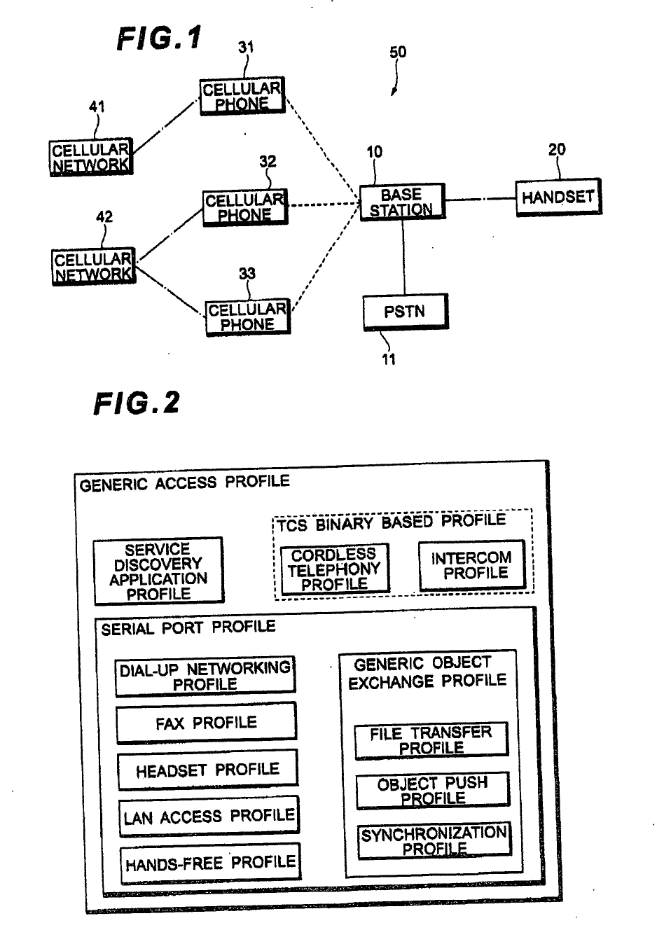

FIG. 1 is a Bluetooth network configuration of the present embodiment.

A Bluetooth network (Piconet) 50 comprises a plurality of cellular phones 31, 32, 33; a base station (cordless phone base unit) 10 to be point-to-multipoint connected to these plurality of cellular phones 31, 32, 33; and a handset (cordless phone sub unit) 20 to be wireless connected to the base station 10.

The cellular phone 31 is wireless connected to the cellular network 41, and cellular phones 32, 33 are wireless connected to the cellular network 42. These cellular networks 41, 42 may each be operated by different carriers, or operated by the same carrier. The base station 10 is connected to a PSTN (public switched telephone network) 11.

The base station 10 functions as the multi-wireless connection device for wireless connection each of the cellular phones 31, 32, 33 and the handset 20. As a result of arranging the cellular phones 31, 32, 33 at a position having favorable radio wave environment indoors, for instance, the incoming calls from the cellular networks 41, 42 to the cellular phones 31, 32, 33 can be received with the base station 10 or the handset 20. Further, by operating the base station 10 or handset 20, outgoing calls can be made from the cellular phones 31, 32, 33 to the cellular networks 41, 42.

In other words, since the cellular phones 31, 32, 33 and the base station 10 are subject to wireless connection, the user is able to operate the handset 20 to control the incoming calls to the cellular phones 31, 32, 33, or the outgoing calls from the cellular phones 31, 32, 33. The base station 10 has a function of relaying the conference call between the talker on the side of the cellular networks 41, 42 and the talker on the side of the landline network.

As the communication link for wireless connecting the plurality of cellular phones 31, 32, 33 and the base station 10, for example, it is desirable to employ a close range wireless connection means such as Bluetooth connection. The Bluetooth standard is a technical standard for wireless connecting communication devices such as cellular phones and PC related equipment, or home electrical appliances. The Bluetooth standard employs a high frequency hopping (16000 hops/second) system, and the maximum data transmission rate is 723.2 kbps, and the transmission distance is roughly 10 m when the transmission power is 1 mW. This standard employs an ISM range of 2.4 GHz, which a user can use without a license, and may be used throughout the world. A maximum of 7 slaves can be simultaneously connected 1 master.

As a result of installing a hands-free profile for point-to-multipoint connection in the respective cellular phones 31, 32, 33 and the base station 10, the base station 10 will be able to perform point-to-multipoint connection to the plurality of cellular phones 31, 32, 33. The hands-free profile for point-to-multipoint connection is a profile in which the hands-free profile for point-to-point connection was improved for point-to-multipoint connection. Point-to-multipoint connection is can be realized by the base station 10 functioning as the master, and controlling the communication link between the plurality of cellular phones (slaves) 31, 32, 33.

By definition of the hands-free profile, the cellular phones 31, 32, 33 function as an audio gateway (AG), and the base station 10 functions as a hands-free unit (HF). The audio gateway is a device that functions as a gateway for inputting and outputting audio signals, The hands-free unit is a device that functions as a remote audio 110 mechanism of the audio gateway.

In the present embodiment, although a cellular phone is exemplified as the audio gateway, it is not limited thereto, and, for instance, a communication device such as a land-line phone, IP phone, Internet-connected computer, LAN-connected computer or the like may also be used.

(Bluetooth Profile)

FIG. 2 is an explanatory diagram of the Bluetooth profile.

The technical specification of Bluetooth is separated into two; namely, core and profile. A core defines the basis of the wireless connection to be provided by Bluetooth. A profile is the technical requirement for guaranteeing the mutual connection of each function upon developing various functions and applications based on the core and incorporating these into actual products. There is a plurality of profiles, and, based on the various combinations thereof, a single application is provided.

A hands-free profile prescribes the minimum functions of the hands-free unit and mobile phone to be mutually connected via the Bluetooth link. This profile, for example, prescribes the technical requirements for remote controlling the mobile phone with the hands-free unit and audio connecting the mobile phone and hands-free unit. In the hands-free profile, a single line of audio channel is defined between the audio gateway and hands-free unit, and the communication mode of point-to-point connection is the basis thereof.

In the present embodiment, a new technical requirement is added to this hands-free profile so as to improve the communication mode of point-to-point connection to the communication mode of point-to-multipoint connection.

There are two types of physical links in Bluetooth communication; namely, the SCO link (Synchronous Connection-Oriented Link) and ACL link (Asynchronous Connection-Less Link), and these may be used properly according to the usage of the application.

The SCO link is connective type that performs communication via point-to-point connection between the master and slave, and is primarily used in applications that require real-time usage such as voice communication. This corresponds to the circuit switching in a wired network, and, a communication slot is secured beforehand in prescribed intervals in the communication link within Piconet, and data communication of SCO link is given priority even when there is other data midway. Although the communication slot is secured in prescribed intervals in the SCO link, when there is an open slot midway, the ACL link may be integrated therein and used.

The ACL link is a connective type that performs point-to-multipoint connection between the master and slave, and is primarily used in applications that do not require real-time usage. This corresponds to packet switching, and, in exchange for enabling the communication with any slave within Piconet, the effective communication rate of the respective slaves may change depending on the data volume and number of slaves, which is why this is used in applications that do not require real-time usage. In exchange for not providing a fixed communication band, a plurality of communication links can coexist in the ACL link.

With the hands-free profile improved for point-to-multipoint connection, the master, by transmitting and receiving control data with a time-division multiplex system between the plurality of slaves via the ACL link, shares the same channel, maintains the synchronization within Piconet, and detects the communication status, incoming call status, dialup status and so on of the respective slaves based on the call status or the like transmitted from the respective slaves via the ACL link. The master determines which audio line with which slave should be opened based on the communication status, incoming call status, dialup status and so on of the respective slaves, forms the SCO link with the slave to which the audio line is to be opened, and receives the SCO packet storing communication audio data from such slave. Even if the master simultaneously receives SCO packets from two or more slaves, since it is only able to output the audio of the SCO packet of either of the slaves, while the SCO link is formed with a certain slave, the master performs link control such that the SCO link is not formed with other slaves. As a result of employing link control as described above, the master will be able to perform point-to-multipoint connection to a plurality of slaves while using the hands-free profile for point-to-point connection.

Incidentally, depending on cellular phone model, when the SCO link is disconnected, there are types that automatically disconnect the ACL link. With this type of cellular phone, since calls will not be received by the master in real time if the SCO link is disconnected by the master without careful consideration, control should be made so as to enable communication with the cellular phone.

(Packet Format)

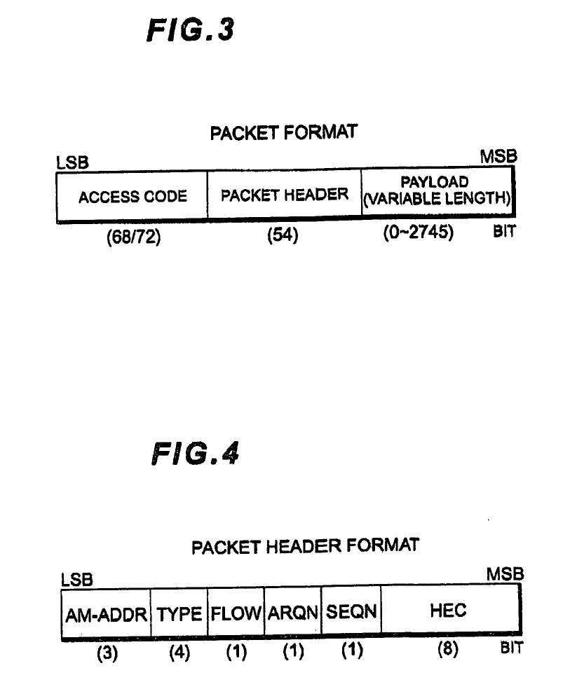

FIG. 3 is an explanatory diagram of the packet format in Bluetooth communication.

As shown in FIG. 3, the packet format contains, from the top, an access code, a packet header and a payload.

The 68 bit or 72 bit data referred to as the access code is like a tag that becomes the basis for indicating the address of the transmission packet, and an access code is always added to all packets that are transmitted and received. Depending on the type of packet, there are packets that are configured from only an access code. The access code has the function of eliminating the signal direct current component, identifying Piconet, extracting the synchmnization timing, among other tasks.

The 54 bit packet header subsequent to the access code contains a parameter for controlling the communication link in the base band layer. There are packets that are configured from only the access code and packet header.

The payload stores user date or control data to be transmitted and received between Bluetooth terminals. As user data, there is data to be transmitted and received via a circuit switching SCO link, and data to be transmitted and received via a packet switching ACL link. Since the number of bits of the payload is of a variable length, it may be expanded up to 2745 bits at maximum.

FIG. 4 is an explanatory diagram of the packet header format.

As shown in FIG. 4, the packet header contains AM_ADDR, TYPE, FLOW, ARQN, SEQN, and HEC.

AM_ADDR is a 3 bit identification field for specifying the slave in communication within Piconet. The AM_ADDR is assigned to the slave by the master.

TYPE is a 4 bit packet type Identification field for designating the type of packet. It is able to define 16 types of packets in relation to the SCO link and ACL link, respectively.

FLOW is a 1 bit field used for managing the flow control of the packet to be communicated via the ACL link.

ARQN is a 1 bit field for notifying the packet transmitter whether there is an error in the reception packet.

SEQN is a 1 bit field for managing the resent packet such that it is not repeated on the receiving end.

HEC is an 8 bit field representing the error detecting codes in relation to the total of 10 bits of AM_ADDR, TYPE, FLOW, ARQN, and SEQN.

(SCO Packet)

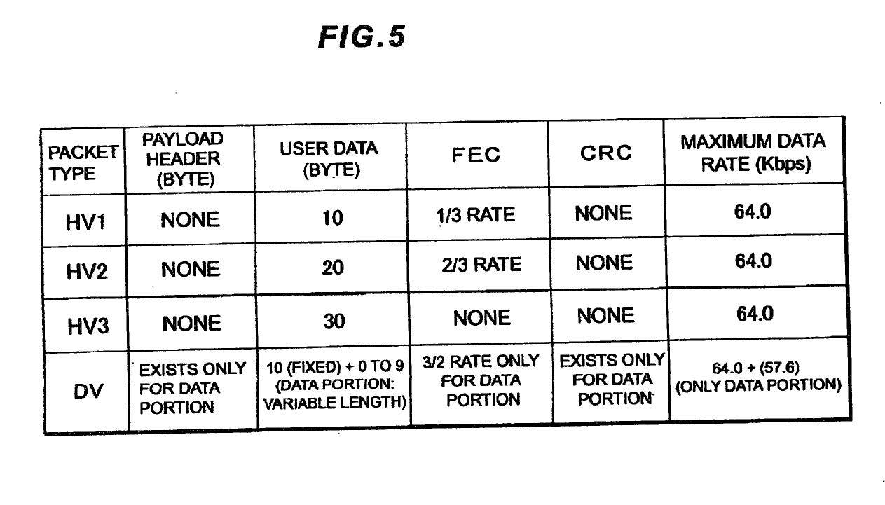

FIG. 5 is an explanatory diagram of the SCO packet.

An SCO packet is the generic designation of the data packet to be transmitted and received on the SCO link, and 4 types of single slot packets are defined therein; namely, HV1 packet, HV2 packet, HV3 packet, and DV packet. The SCO packet is primarily used for transmitting audio of 64 kbps codec. The SCO packet is not resent, and the error detecting code (CRC) is not added to the payload.

The HV1 packet payload is configured from only the payload body, and 10 bytes of user data are stored therein. The data is subject to forward error correction at a ⅓ rate, and will ultimately have a 240 bit payload length. Since the value obtained by dividing 80 bits, which is the user data length of the HV1 packet, with 64 kbps will be 1.25 msec, the transmission packet cycle thereof will be a time duration worth 2 slots.

The HV2 packet payload is configured from only the payload body, and 20 bytes of user data are stored therein. The data is subject to forward error correction at a ⅔ rate, and will ultimately have a 240 bit payload length. Since the value obtained by dividing 160 bits, which is the user data length of the HV2 packet, with 64 kbps will be 2.5 msec, the transmission packet cycle thereof will be a time duration worth 4 slots.

The HV3 packet payload is configured from only the payload body, and 30 bytes of user data are stored therein. The data is not subject to forward error correction, and will ultimately have a 240 bit payload length. Since the value obtained by dividing 240 bits, which is the user data length of the HV3 packet, with 64 kbps will be 3.75 msec, the transmission packet cycle thereof will be a time duration worth 6 slots.

The DV packet is configured from 10 bytes of an audio portion having a fixed length and a data portion having a variable length up to 9 bytes at maximum. Although an error detecting code (CRC) is not added to the 10 bytes of the audio portion, 2 bytes of error detecting code (CRC) in relation to the maximum portion of 10 bytes including the 1 byte payload header is added to the data portion. In other words, although the audio portion of the DV packet will not be resent, the data portion of the DV packet will be resent at a ⅔ rate. Further, this data portion is subject to forward error correction (Rate ⅔ FEC).

(ACL Packet)

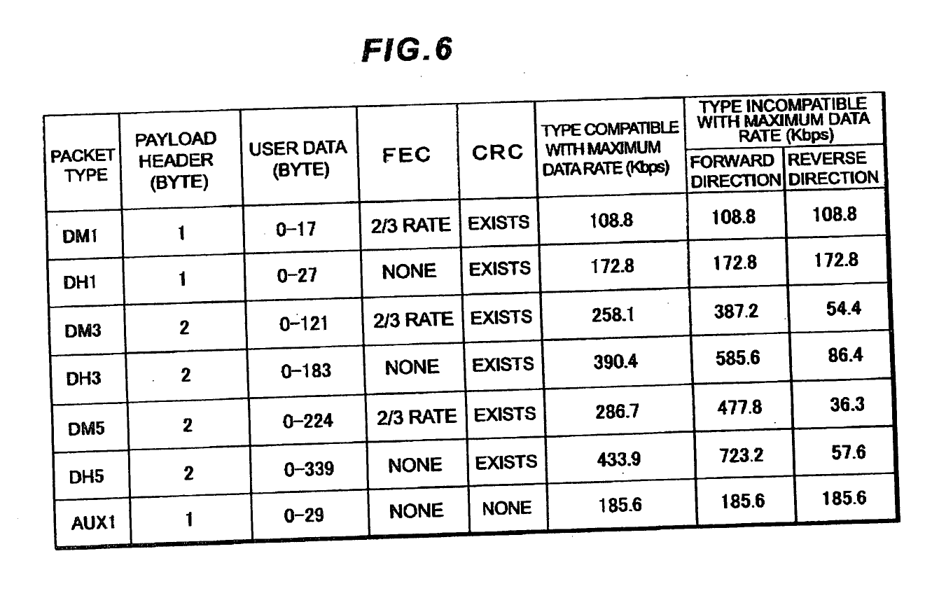

FIG. 6 is an explanatory diagram of the ACL packet.

An ACL packet is the generic designation of the date packet to be transmitted and received on the ACL link, and DM1 packet, DH1 packet, DM3 packet, DH3 packet, DM5 packet, DH5 packet, and AUX1 packet are defined therein. The ACL packet is configured from a payload header (1 byte or 2 bytes), a payload body (variable length), and an error detecting code (2 bytes).

The DM1 packet payload is configured from a 1 bit payload header, a variable length payload body up to a maximum of 17 bytes, and a 2 bit error detecting code (CRC). The payload is subject to forward error correction at a ⅔ rate. The maximum data rate is 108.8 kbps in a symmetrical type, and, in an asymmetrical type, it is 108.8 kbps in the forward direction and 108.8 kbps in the reverse direction.

The configuration of the DH1 packet is the same as the configuration of the DM1 packet. However, the payload is not subject to forward error correction. Therefore, it is possible to transmit and receive variable length data up to a maximum of 27 bytes. The maximum data rate is 172.8 kbps in a symmetrical type, and, in an asymmetrical type, it is 172.8 kbps in the forward direction and 172.8 kbps in the reverse direction.

The DM3 packet payload is configured from 2 bytes of payload header, a variable length payload body up to a maximum of 121 bytes, and 2 bytes of error detecting code (CRC). The transmission/reception slot length of the DM3 packet is 3 slots, and, while this packet is being transmitted and received, the communication frequency is not fixed. The maximum data rate is 258.1 kbps in a symmetrical type, and, in an asymmetrical type, it is 387.1 kbps in the forward direction and 54.4 kbps in the reverse direction.

The configuration of the DH3 packet is the same as the configuration of the DM3 packet. However, the payload is not subject to forward error correction. Therefore, it is possible to transmit and receive variable length data up to a maximum of 183 bytes. The maximum data rate is 390.41 kbps in a symmetrical type, and, in an asymmetrical type, it is 585.6 kbps in the forward direction and 86.4 kbps in the reverse direction.

The DM5 packet payload is configured from 2 bytes of payload header, a variable length payload body up to a maximum of 224 bytes, and 2 bytes of error detecting code (CRC). The transmission/reception slot length of the DM5 packet is 5 slots, and, while this packet is being transmitted and received, the communication frequency is fixed. The maximum data rate is 286.71 kbps in a symmetrical type, and, in an asymmetrical type, it is 477.8 kbps in the forward direction and 36.3 kbps in the reverse direction.

The configuration of the DH5 packet is the same as the configuration of the DM5 packet. However, the payload is not subject to forward error correction. Therefore, it is possible to transmit and receive variable length data up to a maximum of 339 bytes. The maximum data rate is 433.9 kbps in a symmetrical type, and, in an asymmetrical type, it is 723.2 kbps in the forward direction and 57.6 kbps in the reverse direction.

The configuration of the AUX1 packet is the same as the configuration of the DH1 packet that does not contain an error detecting code (CRC). In other words, the AUX1 packet is not resent. In exchange therefor, 2 bytes of payload body may be increased to enable the transmission and reception of variable length data up to a maximum of 29 bytes. The maximum data rate is 185.6 kbps in a symmetrical type, and, in an asymmetrical type, it is 185.6 kbps in the forward direction and 185.6 kbps in the reverse direction.

(Packet Selection Control)

The base station (master) 10 is realizing point-to-multipoint connection by limiting, as much as possible, the packets to be transmitted and received between the plurality of cellular phones (slaves) 31, 32, 33. Thus, it is desirable to compress and store audio data, as much as possible, in the packet to be transmitted and received between the base station 10 and plurality of cellular phones 31, 32, 33. The base station 10 selects the most favorable TYPE of audio transmission efficiency upon connecting the SCO link with the cellular phones 31, 32, 33, and, when the SCO link based on the most favorable audio transmission efficiency is denied, it tries the SCO link having the next best audio transmission efficiency. Like this, communication control suitable for point-to-multipoint connection can be realized by sequentially selecting from the most favorable TYPE of audio transmission efficiency.

(ACL Automatic Connection Control)

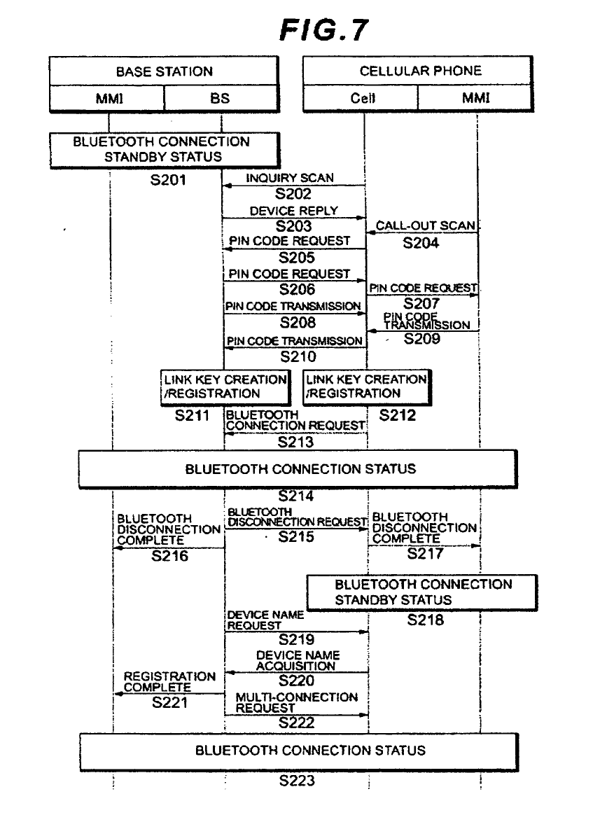

FIG. 7 is a sequence diagram describing the ACL automatic connection.

As the procedure for connecting the ACL link between the base station 10 and plurality of cellular phones 31, 32, 33, if the setting is such that the user has to manually operate the cellular phones 31, 32, 33 for connecting the ACL link with the base station 10, the ACL connection operation will become complex because the ACL link will be frequently connected each time the user takes the cellular phones 31, 32, 33 outdoors.

In light of the foregoing circumstances, in the present embodiment, ACL automatic connection is realized by voluntarily issuing an ACL connection request from the base station 10 to the respective cellular phones 31, 32, 33. In cases where the ACL link cannot be connected due reasons such as the lines of the cellular phones 31, 32, 33 being busy, it is desirable to change the cycle of issuing the ACL connection request so as to avoid disrupting the telephone conversation.

Next, the ACL automatic connection sequence is explained in detail with reference to FIG. 7.

Foremost, let it be assumed that the cellular phones 31, 32, 33 are taken outdoors by the user, and are outside the service area of the Bluetooth network 50 (S101). In this state, the ACL link between the base station 10 and cellular phones 31, 32, 33 is disconnected.

The base station 10 voluntarily makes an ACL connection request to the cellular phones 31, 32, 33 (S102). Here, let it be assumed that the lines of the cellular phones 31, 32, 33 are busy (S103).

The base station 10, after the lapse of a given period of time, voluntarily makes another ACL connection request (S104). Then, the cellular phones 31, 32, 33 return information such as the call status to the base station 10 (105). The base station 10 detects that the lines of the cellular phones 31, 32, 33 are currently busy based on the information such as call status, and changes the setting such that the cycle of issuing the ACL connection request becomes longer.

Next, the cellular phones 31, 32, 33 end their calls (S106), and enter a Bluetooth link standby status (S107).

The base station 10, after the automatic connection cycle is changed, voluntarily makes another ACL connection request (S106). When the cellular phones 31, 32, 33 returns a connection reply to this connection request (S109), the man-machine interface of the base station 10 and cellular phones 31, 32, 33 will display the completion of connection (S110, S111), and the ACL link is connected between the base station 10 and cellular phones 31, 32, 33 (S112).

As described above, as a result of loading the ACL automatic connection function to the base station 10, the user will no longer have to conduct ACL connection operations, and the user-friendliness can be improved.

Further, even if the base station 10 is placed indoors where the radio waves of the cellular networks 41, 42 do not reach, as a result of automatically connecting the ACL link between the base station 10 and the respective cellular phones 31, 32, 33, the base station 10 will be able to detect the incoming calls to the cellular phones 31, 32, 33, and the base station 10 will be able to emit the ring tones in real time.

Moreover, when the lines of the cellular phones 31, 32, 33 are busy, as a result of changing the cycle of issuing the ACL connection request, it will be possible to avoid disrupting the telephone conversation.

(Initial Registration)

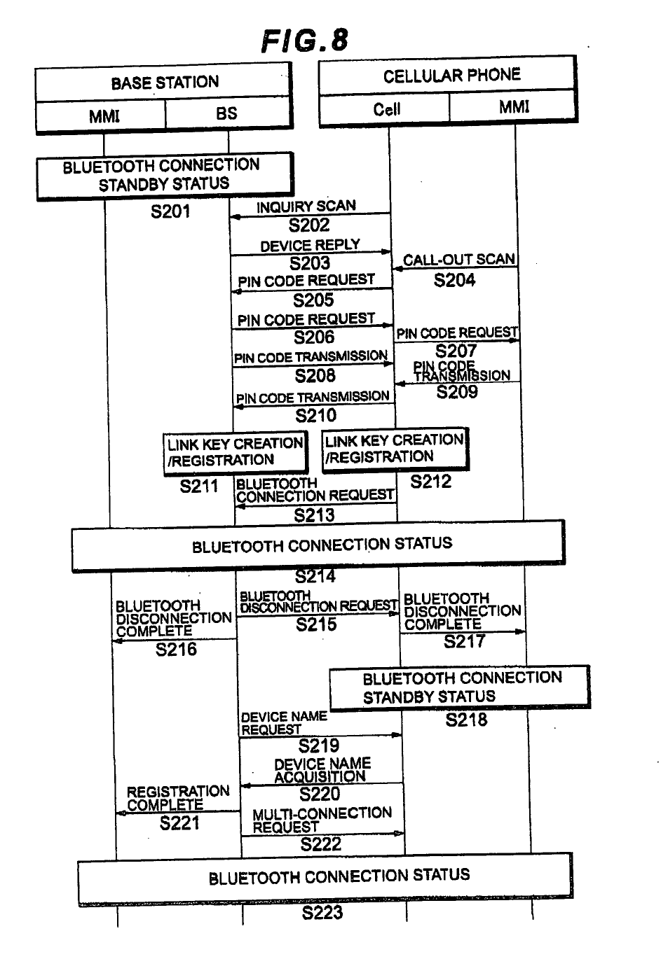

FIG. 8 is a sequence diagram describing the initial registration procedures in the point-to-multipoint connection.

With Bluetooth, when initial registration (pairing) is conducted with the base station 10 on the receiving end, the device name of the cellular phones 31, 32, 33 cannot be acquired. Further, when ACL connection is made based on the connection request from the cellular phones 31, 32, 33 as the master, since the base station 10 will operate as the slave, it will not be possible to perform point-to-multipoint connection.

In light of the foregoing circumstances, in the present embodiment, after the base station 10 operates as the slave upon initial registration and the device ID is acquired from the cellular phones 31, 32, 33, the ACL connection is once disconnected, and the device name of the cellular phones 31, 32, 33 is acquired in a state with no ACL. Thereafter, by connection the ACL link based on the connection request from the base station 10, the base station 10 will operate as the master so as to control point-to-multipoint connection.

Next, the initial registration sequence is explained with reference to FIG. 8.

Foremost, let it assumed that the base station 10 is in a Bluetooth connection standby status (S201). The cellular phones 31, 32, 33 conduct an inquiry scan against the base station 10 (S202), and, upon receiving a device reply (S203), the user conducts a call-out scan via the man-machine interface (S204). Then, the cellular phone 31, 32, 33 requests the PIN code to the base station 10 S205).

Meanwhile, the base station 10 requests the PIN code to the cellular hones 31, 32, 33 (S206). Then, the cellular phones 31, 32, 33 request the PIN code to the user via the man-machine interface (S207).

Further, in response to the foregoing PIN code request (S205), the base station 10 transmits the PIN code to the cellular phones 31, 32, 33 (S208).

When the user inputs the PIN code via the man-machine interface (S209), this PIN code is transmitted from the cellular phones 31, 32, 33 to the base station 10 (S210).

As a result, a link key (initialization key) is created and registered (S207, S208). Thereby, the base station 10 is able to acquire the device ID of the cellular phones 31, 32, 33.

Next, the cellular phones 31, 32, 33 make a Bluetooth connection request to the base station 10 (S209), and changes to the Bluetooth connection status (S210).

Since the base station 10 will operate as the slave in the foregoing status, base station 10 makes a Bluetooth disconnection request to the cellular phones 31, 32, 33 (S211). Then, the Bluetooth disconnection completion is reported to the man-machine interface (S212, S213), and the cellular phones 31, 32, 33 enter the Bluetooth connection standby status (S214).

Next, the base station 10 requests the device name to the cellular phones 31, 32, 33 (S215), and acquires the device name (S216). The registration completion is reported to the man-machine interface of the base station 10 (S217).

Next, the base station 10 requests the point-to-multipoint connection to the cellular phones 31, 32, 33 (S218), and enters the Bluetooth connection status (S219).

According to the foregoing initial registration sequence, the base station 10 is able to acquire the device name of the respective cellular phones 31, 32, 33, and, as a result of operating as the master, the point-to-multipoint connection is also enabled.

(Dialup Control)

In the present embodiment, the dialup with the base station 10 is controlled as follows:
(1) When the receiver of the base station 10 is off the hook, a simulated dial tone is generated for the user to hear;
(2) The dial data is temporarily buffered, and thereafter collectively transmitted to the cellular networks 41, 42; and
(3) When a pause input is made after the dial input, the pause input data is converted into a DTMF signal and output after receiving party receives the incoming call.

According to the outgoing call control described above, since the base station 10 will be able to control the off-hook dialup, compatibility with a fixed line can be established.

(Initial Registration)

When initially connecting the Bluetooth terminals, it is necessary to perform initial registration (pairing). When initial registration is conducted in a state where the base station 10 performs point-to-multipoint connection with the plurality of cellular phones 31, 32, 33 and forms an ACL link or SCO link, the processing load of the base station 10 will increase. Depending on the status of the point-to-multipoint connection, much time may be required for the initial registration.

In light of the foregoing circumstances, in the present embodiment, when the base station 10 is to pair, for instance, with the cellular phone 31, and an ACL link or SCO link is formed with the other cellular phones 32, 33, for example, the ACL link or SCO link with such other cellular phones 32, 33 is once disconnected, and, after pairing with the cellular phone 31, the ACL link or SCO link with such other cellular phones 32, 33 is reestablished. As a result, the processing load of the base station 10 can be alleviated, and the pairing time can also be shortened.

(Call Status)

Depending on the cellular phone model, there are types that do not transmit the call status such as busy line, ring tone ringing, dialing number or the like to the base station 10. With this type of cellular phone, the base station 10 is not able to determine when the ring tone rang, or when the user answered the call.

In light of the foregoing circumstances, in the present embodiment, with this type of cellular phone, the base station 10 acquires the alarm information (ring tone information) transmitted periodically from the cellular phone upon receiving a call so as to detect the incoming call of the cellular phone.

(Auto-Answer)

Depending on the cellular phone model, there are types that automatically open the audio line after receiving the incoming call to the base station 10 connected to the ACL link, so as to connect the SCO link. With this type of cellular phone, problems arise in that the cellular phone would automatically answer the incoming call even though the user has not responded.

In light of the foregoing circumstance, in the present embodiment, with this type of cellular phone, mute processing is performed against auto-answering, and the mute is deactivated by the user's operation, Thereby, inconveniences caused by the auto-answer can be overcome.

(Dialup Control)

In a hands-free profile, when dialing and making a call from the base station 10, if the ACL link is not connected between the base station 10 and cellular phones 31, 32, 33, there is an inconvenience in that the user has to operate the cellular phones 31, 32, 33 to connect the ACL link between the base station 10 and cellular phones 31, 32, 33 in order to dial and make a call from the base station 10.

In light of the foregoing circumstance, in the present embodiment, when a dial input is made from the base station 10 in a state where the ACL link is not connected between the base station 10 and cellular phones 31, 32, 33, foremost, the base station 10 connects the ACL link between the cellular phones 31, 32, 33, and, after the ACL link has been connected, dials and makes a call to the cellular phones 31, 32, 33. Thereby, unnecessary troubles during the dialup from the base station 10 can be omitted.

(Inquiry/Pairing Control)

With a conventional hands-free profile, in order to pair the audio gateway and hands-free unit, it was necessary to conduct the inquiry/pairing from the audio gateway side. This is because most of the hands-free units do not have a display function, and it was necessary to perform operations from the audio gateway side. When the hands-free unit operates as the master to perform point-to-multipoint connection, if the audio gateway is not equipped with a master/slave switching function, there is a problem in that the pairing cannot be performed.

In light of the foregoing circumstance, in the present embodiment, a display function (e.g., LCD device) is provided to the hands-free unit side, and the inquiry/pairing is controlled from the hands-free unit side. As a result, pairing can be performed even to audio gateways that are not equipped with the master/slave switching function, and point-to-multipoint connection will be enabled thereby.

(Point-to-Multipoint Connection)

In order to use Bluetooth communication to realize point-to-multipoint connection, up to three connections of the SCO link may be employed. Nevertheless, if the base unit 10 side is to perform control so as to conduct the point-to-multipoint connection to the plurality of cellular phones 31, 32, 33, real-time incoming calls from the three cellular phones 31, 32, 33 cannot be realized.

In light of the foregoing circumstance, in the present embodiment, the number of registered cellular phones and the number of ACL/SCO link connections are limited to two in order to realize real-time incoming calls.

(SCO Link Control)

In the foregoing Bluetooth network 50, when the SCO link between the cellular phones 31, 32, 33 and the base station 10 is disconnected based on the control from the side of the cellular phones 31, 32, 33, an inconvenience will arise in that the base station 10 will not be able to determine whether the SCO link was disconnected in order to realize a telephone conversation with the cellular phones 31, 32, 33, or because the telephone conversation of the cellular phones 31, 32, 33 has ended.

In light of the foregoing circumstances, in the present embodiment, when the SCO link between the cellular phones 31, 32, 33 and the base station 10 is disconnected, if the call status to be transmitted from the cellular phones 31, 32, 33 is monitored, and the call status of end of call is not transmitted even after the lapse of a given period of time from the disconnection of the SCO link, it will be determined that the telephone conversation of the cellular phones 31, 32, 33 has ended. Thereby, the base station 10 will be able to determine whether the SCO link was disconnected in order to realize a telephone conversation with the cellular phones 31, 32, 33 is to be made, or because the telephone conversation of the cellular phone 31, 32, 33 has ended.

(Line Busy Display Function)

In the foregoing Bluetooth network 50, If a function for displaying the communication status of the cellular phones 31, 32, 33 on the base unit 10 side is not provided, it will be necessary to display the communication status on the side of the cellular phones 31, 32, 33.

In light of the foregoing circumstances, in the present embodiment, a function for displaying the communication state of the cellular phones 31, 32, 33 is provided to the base unit 10.

We claim:

1. A multi-wireless connection device that point-to-multipoint connects a communication link between a plurality of communication devices to be connected to a communication network, and a wireless communication device that remote controls the outgoing calls from said plurality of communication devices to said communication network, or the incoming calls from said communication network to said plurality of communication devices.

2. The multi-wireless connection device according to claim 1, wherein said communication network is a cellular network, said communication device is a cellular phone, said wireless communication device is a cordless phone, and said communication link is a Bluetooth link.

3. The multi-wireless connection device according to claim 2, wherein said multi-wireless connection device maintains the synchronization within the Bluetooth network by transmitting and receiving control data between said plurality of communication devices via an ACL link.

4. The multi-wireless connection device according to claim 3, wherein said multi-wireless connection device connects an SCO link with one of said plurality of communication devices by receiving a call status from said communication devices.

5. The multi-wireless connection device according to claim 1, wherein, when the communication link with said communication devices is disconnected, the communication link with said communication devices is connected by voluntarily issuing a communication link connection request.

6. The multi-wireless connection device according to claim 5, wherein, when the line of said communication devices is busy, the cycle of issuing said communication link connection request is changed.

7. The multi-wireless connection device according to claim 2, wherein, when connecting an SCO link with said communication devices, the SCO link is connected in order from the highest transmission efficiency of audio data.

8. The multi-wireless connection device according to claim 2, wherein, when a pause input is made subsequent to a dial input to said multi-wireless connection device, said multi-wireless connection device converts the dial data subsequent to the pause input into a DTMF signal and transmits this signal after the reply of an incoming call terminal.

9. The multi-wireless connection device according to claim 2, wherein, after pairing with said communication devices, the ACL link with said communication devices is disconnected, and, after acquiring a device name from said communication devices, the ACL link with said communication devices is connected.
